(19) United States
(12) Patent Application Publication
(10) Pub. No.: US 2010/0154970 A1
(43) Pub. Date: Jun. 24, 2010

(54) Method of Forming Leg Cuffs for Wearable Articles and Articles Made Thereby

(76) Inventor: Michael L. Lohoff, Oshkosh, WI (US)

Correspondence Address: KIMBERLY-CLARK WORLDWIDE, INC.;Tara Pohlkotte, 2300 Winchester Rd., NEENAH, WI, 54956, US

(21) Appl. No.: 12/716,689

(22) Filed: Mar. 3, 2010

Related U.S. Application Data
(62) Division of application No. 10/883,171, filed on Jun. 30, 2004, now abandoned.

(51) Int. Cl. B29C 65/08; B32B 37/00; B32B 37/12

(52) U.S. Cl. 156/73.1; 156/163

(57) ABSTRACT

A method of forming an elasticised leg cuff for a wearable article is disclosed. In particular embodiments, the method includes providing a first web of material for forming at least part of an outer cover for a wearable article, the first web defining a first surface and an opposed second surface; cutting a web of leg band material to form a discrete leg band having a first, shaped outer portion and a second, inner portion; connecting the shaped outer portion of the discrete leg band to the first surface of the first web so that the inner portion of the discrete leg band extends laterally from a side edge of the first web; connecting an elastic component to the first web, adjacent the discrete leg band; and folding the inner portion of the leg band over the elastic component and connecting it to the second surface of the first web so as to cover at least a portion of the elastic component. Also disclosed is a wearable article and a outer cover for use therein that includes a first web which defines a first surface and an opposed second surface; a pair of opposed, elasticised leg cuffs, each elasticised leg cuff including a discrete leg band having a first, shaped outer portion connected to the first surface of the first web, and a second, inner portion connected to the second surface of the first web; and an elastic component connected to the first web so as to be sandwiched between the leg band and the first web.

This application is a divisional of application Ser. No. 10/883,171 entitled Method of Forming Leg Cuffs for Wearable Articles and Articles Made Thereby and filed in the U.S. Patent and Trademark Office on Jun. 30, 2004.

### BACKGROUND OF THE INVENTION

The present invention relates to a method of forming leg cuffs for wearable articles. More specifically, the invention relates to a method of applying an elasticised leg cuff to an outer cover for a pant-like absorbent garment. The invention also relates to an absorbent article with elasticised leg cuffs.

Absorbent articles such as diapers, training pants, adult incontinence garments, and the like generally are formed from a liquid pervious bodyside liner, a liquid impervious outer cover, and an absorbent assembly sandwiched between the bodyside liner and the outer cover. Typically, these garments include a pair of leg openings having elasticised portions which are designed to form a snug fit around a wearer's legs to prevent leakage from the garment.

The elasticised portions can be formed by placing tensioned elastic strands along longitudinal edges of the leg openings. When relaxed, the elastic strands contract to form gathers of material around the leg openings. Often, the gathered leg openings appear unsightly in that edges of the web materials surrounding the leg openings appear rough and unfinished.

Consumer perceptions of softness and comfort are important factors in the field of disposable absorbent articles, and accordingly attempts have been made to improve the appearance and the perceived comfort of leg opening edges on absorbent articles. For example, some absorbent articles have material wrapped over the edges of the leg openings to form leg cuffs. This may be achieved by folding at least one layer of the outer cover material over the edges of the leg openings, or by using separate pieces of material to form the leg cuffs. In the latter case, the shape of the leg cuffs may be selected to emphasise certain garment features such as, for example, crotch width, crotch length and elastic profiles. In many of the known designs, an elastic component is wrapped or otherwise connected to a carrier material which subsequently is applied to a web to form a leg cuff on the web. The elastic components are functional and serve to improve the fit of the leg openings around a wearer's legs, whereas the carrier material serves primarily to address consumer perceptions of softness and comfort. In these designs, a change in the shape of the leg cuff requires changes to both the carrier material and the elastic component, i.e. simple changes to the carrier material cannot be made independently of the elastic component which typically is designed for a specific purpose.

It is desirable to select the shape and/or the material of a leg band for an elasticised leg cuff to suit a specific application.

It is also desirable to effect changes to the shape and/or the material of the leg band without having to effect changes to an elastic component of the leg cuff.

### SUMMARY OF THE INVENTION

The present invention is directed to a method of forming an elasticised leg cuff for a wearable article such as a diaper, a training pant, an incontinence garment, or swim wear. The method involves applying a leg band to an outer cover for a wearable article independently of a leg elastic so as to allow for changes in the shape and/or the material of the leg band independently of the leg elastic.

According to a first aspect of the invention, there is provided a method of forming an elasticised leg cuff for a wearable article comprising:

providing a first web of material for forming at least part of an outer cover for a wearable article, the first web defining a first surface and an opposed second surface;

cutting a web of leg band material to form a discrete leg band having a first, shaped outer portion and a second, inner portion;

connecting the shaped outer portion of the discrete leg band to the first surface of the first web so that the inner portion of the discrete leg band extends laterally from a side edge of the first web;

connecting an elastic component to the first web, adjacent the discrete leg band; and

folding the inner portion of the leg band over the elastic component and connecting it to the second surface of the first web so as to cover at least a portion of the elastic component.

The web of leg band material may be cut to form a shaped outer portion having any desired shape. For example, the outer portion of the leg band may include straight or substantially straight edges, such as where the outer portion is rectangular or substantially rectangular in shape, or it may include at least one curved edge.

The first web may comprise material for forming a single-layer outer cover. Alternatively, the first web may comprise material for forming an outer layer of the outer cover, and the method may include the step of connecting an inner layer for the outer cover to the first web. In this aspect of the invention, a second web of material for forming the inner layer for the outer cover may be connected to the second surface of the first web before or after the elastic component is connected to the second surface of the first web.

The first web may include curved leg openings, and the shaped outer portion of the leg band may be connected to the first web adjacent a curved leg opening. In this case, the folded leg band may be cut to re-form a curved leg opening in the outer cover.

In one aspect of the invention, the web of leg band material is cut and shaped so as to include a shaped outer portion and a shaped inner portion.

Suitably, the web of leg band material is stretchable, and more suitably is elastic.

The discrete leg band may be connected to the first web with adhesive, or it may be connected to the first web by means of thermal bonding, ultrasonic bonding, pressure bonding or the like.

In one aspect of the invention, the discrete leg band is stretched prior to connecting the outer portion thereof to the first web.

The elastic component may be a discrete, curved leg elastic which is connected to the first web adjacent a leg opening in the first web. Alternatively, the elastic component may be a straight leg elastic, which may be discrete or continuous.

The elastic component may comprise an elastic band or ribbon, or elastic strands. Alternatively, the elastic component may comprise a composite elastic material.

The elastic component may be adhesively bonded to the first web, or it may be connected to the first web by means of thermal bonding, ultrasonic bonding, pressure bonded or the like.

Desirably, the elastic component is stretched prior to being connected to the first web.

The invention extends to an outer cover for a wearable article comprising:

a first web which defines a first surface and an opposed second surface;

a pair of opposed, elasticised leg cuffs, each elasticised leg cuff including:
a discrete leg band having a first, shaped outer portion connected to the first surface of the first web, and a second, inner portion connected to the second surface of the first web; and
an elastic component connected to the first web so as to be sandwiched between the leg band and the first web.

The outer cover may include a second web connected to the second surface of the first web to form an inner layer of the outer cover.

In one aspect of the invention, the second, inner portion of the leg band is shaped.

The elasticised leg cuffs may extend along curved leg openings in the outer cover.

Suitably, the discrete leg bands are formed from a stretchable material, which may be elastic.

Typically, the elastic component is a discrete leg elastic, but it may be continuous. In one aspect of the invention, the elastic component is a discrete, curved leg elastic located adjacent a curved leg opening in the outer cover.

The leg elastic may comprise an elastic band or ribbon, or elastic strands. Alternatively, the elastic component may comprise a composite elastic material.

The invention extends further to an absorbent garment comprising:
a liquid pervious bodyside liner;
a liquid impervious outer cover; and
an absorbent assembly sandwiched between the bodyside liner and the outer cover;
wherein the outer cover comprises:
a first web which defines a first surface and an opposed second surface;
a pair of opposed, elasticised leg cuffs, each elasticised leg cuff including:
a discrete leg band having a first, shaped outer portion connected to the first surface of the first web, and a second, inner portion connected to the second surface of the first web; and
an elastic component connected to the first web so as to be sandwiched between the leg band and the first web.

The broad scope of the applicability of the present invention will become apparent to those of skill in the art from the details given below.

The detailed description of the preferred embodiments of the invention is given by way of example only, and various modifications within the scope of the invention will be apparent to those of skill in the art.

### BRIEF DESCRIPTION OF THE DRAWINGS

FIG. 1 is a perspective view of an absorbent garment, with a portion cut away to show an underlying feature.

FIG. 2 is a top view of an outer cover for forming an absorbent garment of the type illustrated in FIG. 1.

FIG. 3 is a cross-sectional view along the line 3-3 in FIG. 2.

FIG. 4 is a schematic side view of an apparatus for forming outer covers according to a first aspect of the present invention.

FIG. 5 is a top view of a first portion of a web during the production of outer covers of the type illustrated in FIG. 2 in accordance with the first aspect of the invention.

FIG. 6 is a cross-sectional view along the line 6-6 in FIG. 5.

FIG. 7 is a schematic side view of a device for attaching leg elastics to the outer cover in accordance with the first aspect of the invention.

FIG. 8 is a top view of a second portion of the web during the production of outer covers in accordance with the first aspect of the invention.

FIG. 9 is a cross-sectional view along the line 9-9 in FIG. 8.

FIG. 10 is a top view of a third portion of the web.

FIG. 11 is a cross-sectional view along the line 11-11 in FIG. 10.

FIGS. 12 and 13 show schematic side views of devices for folding leg bands on the web.

FIG. 14 is a top view of a fourth portion of the web.

FIG. 15 is a cross-sectional view along the line 15-15 in FIG. 14.

FIG. 16 is a top view of a fifth portion of the web.

FIG. 17 is a cross-sectional view along the line 17-17 in FIG. 16.

FIG. 18 is a schematic side view of an apparatus for forming outer covers according to a second aspect of the present invention.

FIG. 19 is a schematic side view of a device for attaching leg elastics to the outer cover in accordance with a second aspect of the present invention.

FIG. 20 is a top view of a first portion of a web during the production of outer covers for absorbent garments in accordance with the second aspect of the invention.

FIG. 21 is a cross-sectional view along the line 21-21 in FIG. 20.

FIG. 22 is a top view of a second portion of a web during the production of outer covers in accordance with the second aspect of the invention.

FIG. 23 is a cross-sectional view along the line 23-23 in FIG. 22.

FIG. 24 is a top view of a portion of a web during the production of outer covers for absorbent garments in accordance with a third aspect of the invention.

FIG. 25 is a cross-sectional view along the line 25-25 in FIG. 24.

### DEFINITIONS

As used herein, the terms “connecting”, “bonding” and “attaching” mean the joining of surfaces on two elements. For the purposes of this specification, two elements are to be considered connected, bonded or attached together when they are joined directly to one another or indirectly to one another, such as when each is directly joined to intermediate elements.

As used herein, the term “disposable”, when used to describe articles such as garments, means an article which is designed to be discarded after a limited use rather than being laundered or otherwise restored for use.

As used herein, the term “elastic”, when used to describe a material, means that property of the material by virtue of which it tends to recover its original size and shape, or a high percentage thereof, after removal of a force causing deformation.

As used herein, the term “extensible”, when used to describe a material, means a material that is capable of being extended or protruded in length or breadth.

As used herein, the term “flexible”, when used to describe a material, means a material which is compliant and which will readily conform to the general shape and contour of a wearer's body.

As used herein, the term “liquid impermeable”, when used to describe a layer or multi-layer laminate, means that a liquid, such as urine, will not pass through the layer or laminate, under ordinary use conditions, in a direction generally perpendicular to the plane of the layer or laminate at the point of liquid contact, and “liquid permeable” means a layer or laminate that is not liquid impermeable.

As used herein, the term “machine direction”, when used with respect to a fabric or material, means the direction along the length of the fabric or material in which it is produced or converted, as opposed to “cross direction” or “cross-machine direction” which refers to the direction along the width of the fabric or material, generally perpendicular to the machine direction.

As used herein, the term “stretchable”, when used to describe a material, means a material that can be stretched, without breaking, by at least 50% in at least one direction, suitably by at least 100%, and most suitably by at least 150%. The term “stretchable” includes elastic materials as well as extensible materials that stretch but do not significantly retract.

As used herein, the term “biaxial stretchability”, when used to describe a material, means a material having stretchability in both the machine direction and the cross-machine direction.

As used herein, the term “comprising” is intended to be inclusive or open-ended, and is not intended to exclude additional elements or method steps which do not prevent operation of the invention.

### DETAILED DESCRIPTION OF THE INVENTION

The present invention is directed to a method of forming elasticised leg cuffs on wearable garments, such as disposable absorbent articles. Examples of suitable articles for use with the present invention include, but are not limited to, diapers, training pants, feminine care products, adult incontinence products, disposable apparel, other personal care or health care garments, and the like. For ease of explanation, the description hereafter will be made with reference to a child's training pant. Generally, these garments include a pair of leg openings and an elastic portion around each leg opening for preventing leakage from the garment and for providing a finished look or appearance.

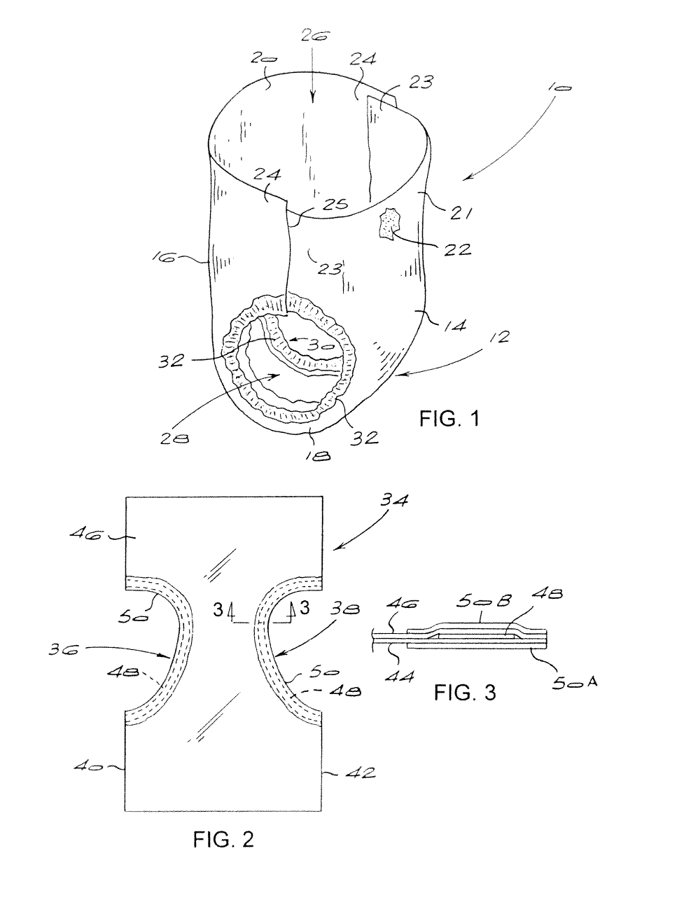

FIG. 1 of the drawings illustrates a pant-like disposable absorbent article such as a training pant 10 in a fastened condition. The absorbent article includes a chassis 12 which defines a front region 14, a rear region 16, and a crotch region 18 interconnecting the front and rear regions. The chassis 12 includes a liquid permeable bodyside liner 20 for contacting a wearer's body, and a liquid impermeable outer cover 21 for contacting the wearer's clothing. An absorbent assembly 22 may be sandwiched between the bodyside liner 20 and the outer cover 21. The absorbent article 10 includes transversely opposed, front side panel portions 23 on the front region 14 of the chassis 12, and transversely opposed rear side panel portions 24 on the rear region 16 of the chassis 12. The front and rear side panel portions 23 and 24 are releasably attachable to one another by a fastening system 25. The absorbent chassis 12 and the fastening system 25 together define a refastenable pant having a waist opening 26, and a pair of leg openings 28 and 30. Alternatively, the front side panel portions 23 may be permanently bonded to the rear side panel portions 24 to form a closed pant-like disposable absorbent article. Elasticised Leg cuffs 32 extend around the leg openings 28 and 30 of the absorbent article 10, as shown. The leg cuffs 32 provide gaskets for reducing or preventing leakage around the leg openings, between the absorbent article 10 and the legs of the wearer.

The outer cover 21 of the absorbent article 10 suitably comprises a material which is substantially liquid impermeable. The outer cover 21 can be a single layer of liquid impermeable material, but more suitably comprises a multi-layered laminate structure in which at least one of the layers is liquid impermeable. For instance, the outer cover 21 can include a liquid permeable outer layer and a liquid impermeable inner layer that are suitably joined together by a laminate adhesive, ultrasonic bonds, thermal bonds, or the like. The liquid permeable outer layer can be any suitable material and desirably is one that provides a generally cloth-like texture, for example a 20 grams per square meter (gsm) spunbond polypropylene nonwoven web. The inner layer of the outer cover 21 can be both liquid and vapor impermeable, or it may be liquid impermeable and vapor permeable. The inner layer can be manufactured from a thin plastic film, although other flexible liquid impermeable materials may also be used. The inner layer, or the liquid impermeable outer cover 21 when a single layer, prevents waste material from wetting articles, such as bed sheets and clothing, as well as the wearer and caregiver. One example of a liquid impermeable film for use as a liquid impermeable inner layer, or a single layer liquid impermeable outer cover 21, is a 0.02 millimeter polyethylene film commercially available from Pliant Corporation of Schaumburg, Ill., U.S.A.

More suitably, the outer cover 21 is stretchable, and even more suitably the outer cover is elastic. For example, the outer cover 21 may be constructed of a single layer, multiple layers, laminates, films, nonwoven fabrics, elastic netting, microporous webs, bonded carded webs or foams comprised of elastomeric or polymeric materials. The materials may be extensible or stretchable in one direction or they may be biaxially extensible or stretchable. Elastomeric non-woven laminate webs can include a non-woven material joined to one or more gatherable non-woven webs, films, or foams. Stretch Bonded Laminates (SBL) and Neck Bonded Laminates (NBL) are examples of elastomeric composites. A non-woven fabric is any web of material which has been formed without the use of a textile weaving process which produces a structure of individual fibers that are interwoven in an identifiable repeating manner.

Examples of suitable materials are spunbond-meltblown fabrics, spunbond-meltblown-spunbond fabrics, spunbond fabrics, or laminates of such fabrics with scrims, films, foams, or other non-woven webs. Elastomeric materials may include cast or blown films, foams, or meltblown fabrics composed of polyethylene, polypropylene, or polyolefin copolymers, as well as combinations thereof. The elastomeric materials may include PEBAX® elastomer (available from AtoChem located in Philadelphia, Pa., U.S.A.), HYTREL® elastomeric polyester (available from E. I. DuPont de Nemours of Wilmington, Del., U.S.A.), KRATON® elastomer (available from Kraton Polymers of Houston, Tex., U.S.A.), or strands of LYCRA® elastomer (available from Invista of Wilmington, Del., U.S.A.), or the like, as well as combinations thereof. The outer cover 21 may include materials that have elastomeric properties through a mechanical process, printing process, heating process, or chemical treatment. For example, such materials may be apertured, creped, neck-stretched, heat activated, embossed, and/or micro-strained; and may be in the form of films, webs, and/or laminates.

In one aspect of the invention, the outer cover 21 may comprise a 13.6 gsm basis weight layer of G2760 KRATON elastomer strands adhesively laminated with a 0.3 gsm layer of adhesive to at least one facing. The facing can be composed of a thermal point bonded bicomponent spunbond non-woven fibrous web having a 23.7 gsm basis weight.

The bodyside liner 20 of the absorbent article 10 is suitably compliant, soft-feeling, and non-irritating to the wearer's skin. The bodyside liner 20 is also sufficiently liquid permeable to permit liquid body exudates to readily penetrate through its thickness to the absorbent assembly 22. A suitable bodyside liner 20 may be manufactured from a wide selection of web materials, such as porous foams, reticulated foams, apertured plastic films, woven and non-woven webs, or a combination of any such materials. For example, the bodyside liner 20 may comprise a meltblown web, a spunbonded web, or a bonded-carded-web composed of natural fibers, synthetic fibers or combinations thereof. The bodyside liner 20 may be composed of a substantially hydrophobic material, and the hydrophobic material may optionally be treated with a surfactant or otherwise processed to impart a desired level of wettability and hydrophilicity.

The bodyside liner 20 may also be stretchable, and more suitably it may be elastic. Elastomeric materials suitable for constructing the bodyside liner 20 include elastic strands, LYCRA elastics, cast or blown elastic films, nonwoven elastic webs, meltblown or spunbond elastomeric fibrous webs, as well as combinations thereof. Examples of suitable elastomers include KRATON elastomers, HYTREL elastomers, ESTANE elastomeric polyurethanes (available from B.F. Goodrich and Company of Cleveland, Ohio, U.S.A.), or PEBAX elastomers.

The bodyside liner 20 and the outer cover 21 may be attached to one another along at least a portion of their periphery by adhesive, ultrasonic bonding, thermal bonding or other suitable attachment means known in the art.

The absorbent assembly 22 is suitably compressible, conformable and capable of absorbing and retaining liquid body exudates released by the wearer. The absorbent assembly may comprise a single, integral piece of material, or alternatively it may comprise a plurality of individual separate pieces of material which are operatively assembled together.

In one aspect of the invention, the absorbent assembly 22 comprises a matrix of hydrophilic fibers, and more suitably cellulosic fluff, such as wood pulp fluff, and superabsorbent particles. One suitable pulp fluff is identified with the trade designation CR1654, commercially available from U.S. Alliance, Childersburg, Ala., U.S.A., and is a bleached, highly absorbent sulfate wood pulp containing primarily soft wood fibers and about 16% hardwood fibers. As an alternative to wood pulp fluff, synthetic fibers, polymeric fibers, meltblown fibers, short cut homofil bicomponent synthetic fibers, or other natural fibers may be used. Suitable superabsorbent materials can be selected from natural, synthetic, and modified natural polymers and materials. The superabsorbent materials can be inorganic materials, such as silica gels, or organic compounds, such as crosslinked polymers, for example, sodium neutralized polyacrylic acid. Suitable superabsorbent materials are available from various commercial vendors, such as Dow Chemical Company of Midland, Mich., U.S.A., and Stockhausen Inc., Greensboro, N.C., U.S.A.

The absorbent assembly 22 suitably has a density within the range of about 0.10 to about 0.5 grams per cubic centimeter and may be wrapped or encompassed by a suitable tissue or nonwoven wrap for maintaining the integrity and/or the shape of the absorbent structure.

The fastening system 25 may comprise any refastenable fasteners suitable for absorbent articles, such as adhesive fasteners, cohesive fasteners, mechanical fasteners, or the like. In one aspect of the invention, the fastening system comprises mechanical fastening elements for improved performance. Suitable mechanical fastening elements can be provided by interlocking geometric-shaped materials, such as hooks, loops, bulbs, mushrooms, arrowheads, balls on stems, male and female mating components, buckles, snaps, or the like.

FIGS. 2 and 3 illustrate an outer cover 34 for forming a pant-like disposable absorbent article of the type illustrated in FIG. 1. As can be seen, the outer cover 34 includes a pair of curved leg openings 36 and 38 along substantially parallel side edges 40 and 42 thereof. In this aspect of the invention, the outer cover 34 comprises a laminate structure which includes a liquid permeable outer layer 44 and a liquid impermeable inner layer or moisture barrier 46, as representatively illustrated in FIG. 3.

A leg elastic 48 is sandwiched between the outer layer 44 and the inner layer 46 of the outer cover, adjacent each leg opening 36 and 38. The leg elastics 48 are of the curved type, as opposed to straight leg elastics, i.e. leg elastics that are attached to a substrate in a straight line. Generally, curved leg elastics are more form-fitting than straight leg elastics, and the leg openings are gathered with less tension, resulting in an absorbent garment with increased comfort. A wide variety of elastic materials may be used for the leg elastics 48. Suitable elastic materials include sheets, strands or ribbons of natural rubber, synthetic rubber, or thermoplastic elastomeric polymers. In one aspect of the invention, the leg elastics may include a plurality of dry-spun coalesced multi-filament spandex elastomeric threads sold under the trade name LYCRA and available from Invista of Wilmington, Del., U.S.A.

Leg bands 50 extend along edges of the outer cover 34 adjacent the leg openings 36 and 38, as shown. Each leg band 50 includes a shaped, outer portion 50A connected to the outer layer 44 of the outer cover, and an inner portion 50B connected to the inner layer 46 of the outer cover. The leg bands are applied to the outer cover 34 in a manner which is described in more detail below.

Each leg band 50 suitably is formed from a soft, pliable, non-irritating nonwoven material, and is discrete. The leg bands may be extensible, and can be elastic. Generally, the web material used to form the leg bands 50 may comprise a wide range of materials such as, for example, porous foams; reticulated foams; apertured plastic films; or woven or non-woven webs of natural fibers such as wood or cotton fibers, synthetic fibers such as polyester or polypropylene fibers, or a combination of natural and synthetic fibers. Examples of other materials which may be used include, without limitation, spandex/nonwoven laminated webs, elastomeric meltblown webs, cross-machine direction stretchable web materials made with stretchable nonwovens, stretchable foam webs, and the like.

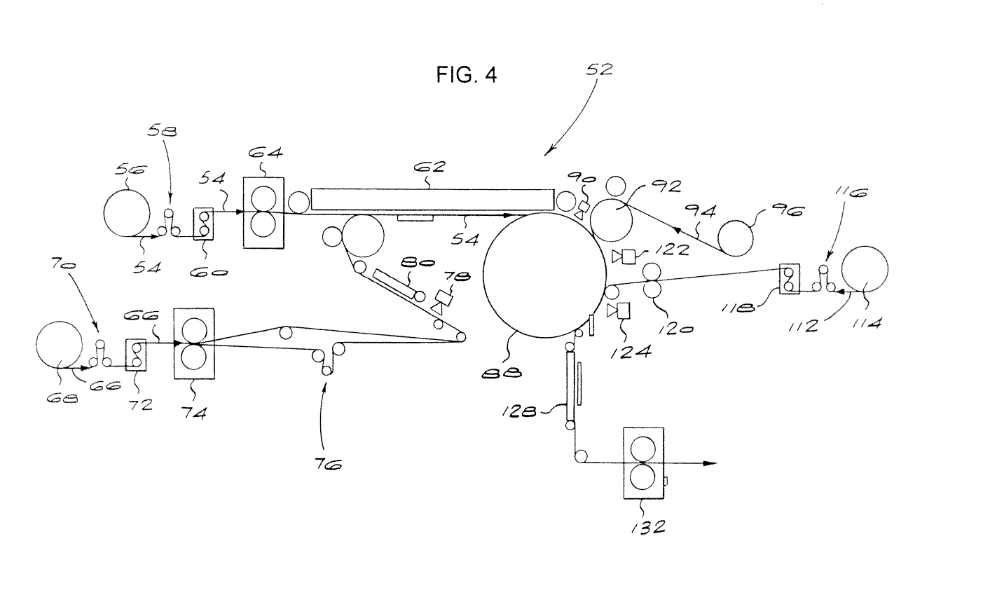

FIG. 4 shows a schematic side view of an apparatus 52 for forming outer covers of the type illustrated in FIG. 2 according to a first aspect of the present invention. In this aspect of the invention, a web 54 of material for forming the outer layers 44 of the outer covers 34 may be unwound from a supply roll 56 which may be driven by a variable speed drive (not illustrated). The web 54 passes through a web tension dancer roll 58 and a web guide 60 which ensure web tension control and web path control. The web 54 may then pass onto a vacuum conveyor 62 via a die cutter 64 in which the web may be shaped to form curved leg openings on opposed lateral sides thereof.

At the same time, a web 66 of material for forming the leg bands 50 is unwound from a supply roll 68 which is also driven by a variable speed drive roll (not illustrated), and which operates in conjunction with a web tension dancer roll 70 and a web guide 72 to ensure that this web is unwound with web tension control and web path control. The web 66 may pass through a die cutter 74, which shapes and cuts the leg bands 50, and a web path adjustment arrangement 76, which brings the left and right die-cut leg bands 50 into alignment with one another. An adhesive applicator 78 may be used to apply adhesive to shaped portions of the leg bands 50, and a vacuum feed conveyor 80 may be used to feed the leg bands 50 into engagement with the web 54 on the vacuum conveyor 62 so as to bond the leg bands to this web.

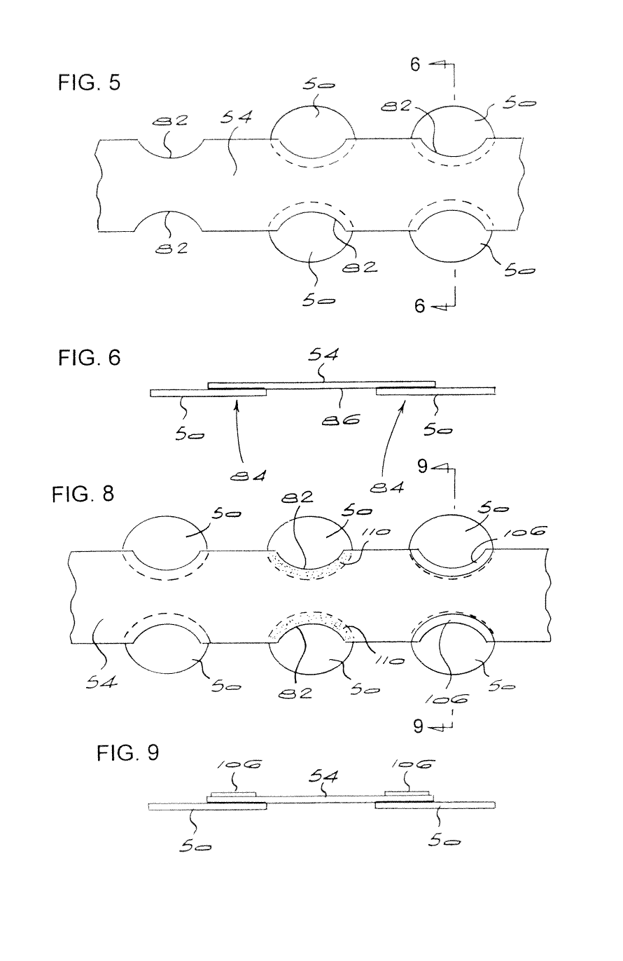

FIG. 5 shows a top view of a portion of the web 54 as it passes through the vacuum conveyor 62, with the vacuum conveyor omitted for clarity. As can be seen, the web 54 includes curved leg openings 82, and the leg bands 50 are bonded to the web 54 adjacent these leg openings. As representatively illustrated in FIG. 6 of the drawings, shaped portions 84 of the leg bands 50 may be bonded to an operatively outer surface 86 of the web 54.

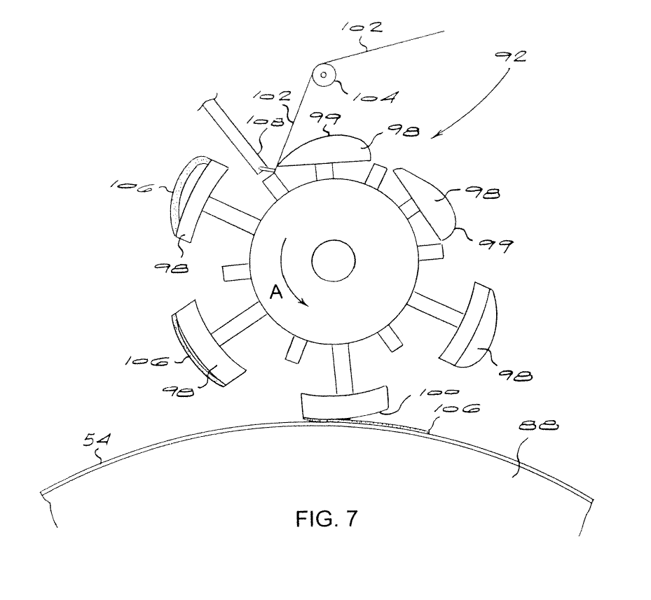

With reference again to FIG. 4, after emerging from the vacuum conveyor 62, the web 54 and the attached leg bands 50 can travel over a vacuum assembly drum 88. An adhesive applicator 90 may be used to apply adhesive to the web 54, adjacent the curved leg openings 82, and leg elastics may then be applied to the web 54 on the vacuum assembly drum 88. In this aspect of the invention, the leg elastics are curved leg elastics which are applied to the web 54 by means of a pair of rotating devices 92 which receive elastic material 94 from a supply roll 96. One of the rotating devices 92 is illustrated in more detail in FIG. 7 of the drawings in which it is seen to carry semi-curved pucks 98. “Semi-curved” refers to a puck having at least one curved surface which extends partially around the puck, but less than all the way around the puck. The semi-curved pucks 98 desirably have curved contours on at least two adjacent surfaces. The curved surfaces may vary in degrees of curvature along their lengths, with optimal curvature of a first of the curved surfaces 99 of each puck 98 conforming to the curvature of one of the leg openings 82 on the web 54, and optimal curvature of a second of the curved surfaces 100 of each puck 98 being such that it forms a rolling action when the puck is in position to transfer and bond a strip of elastic ribbon 102 to the web 54. Each rotating device 92 rotates in a direction complementary to the machine direction movement of the web 54, as indicated generally by the arrow “A” in FIG. 7.

The rotating devices 92 carrying the pucks 98 may be similar to those described in U.S. Pat. No. 6,533,879 to Quereshi et al., the contents of which are incorporated herein by reference to the extent that they are consistent with the present disclosure. For each rotating device 92, an elastic ribbon 102 is fed to the pucks 98 via a guide roll 104, and the elastic ribbon is deflected onto each rotating puck, so as to follow the contours of the first curved surface 99 of the puck, and is cut into a strip 106 by a cutting device 108. Examples of suitable cutting devices include mechanical pinch-type cut-off knives, shear-type cut-off knives, and hot knives or other cutting means well known in the art. The elastic strips 106 suitably are stretched to at least 125%, more suitably at least 150%, of their initial (unstretched) length as they are applied to the pucks 98.

A vacuum within the pucks 98 can be used to hold the elastic strips 106 in place on the pucks. Alternatively, or additionally, each puck may have a non-slip texture on at least part of the second curved surface thereof for holding the elastic strips 106 in place.

Each elastic strip 106 is then carried on a puck 98 by the rotating device 92 into engagement with the web 54, and is deposited onto the web along a curvilinear path so as to form a curved leg elastic on the web. As each puck 98 is displaced from the elastic-application position to the web-bonding position, the puck is radially displaced to increase the pitch. At the same time, the puck 98 is rotated approximately 45-135 degrees from a position in which the first curved surface 99 of the puck is at a radially outermost position, to a position in which the second curved surface 100 of the puck is at a radially outermost position for bonding the elastic strip 106 to the web 54 by means of the adhesive applied to the web with the adhesive applicator 90. The bonds formed as the pucks 98 deposit the elastic strips 106 onto the web 54 are strong enough to separate the elastic strips from the vacuums in the pucks 98, or alternatively from the non-slip textures of the pucks. As a further alternative, the vacuums in the pucks 98 can be released as the elastic strips 106 are deposited onto the web 54.

As the elastic strips 106 are bonded to the web 54, the rotating device 92 continues to rotate the pucks 98, advancing the pucks from the web-bonding position back towards the elastic-application position, and the pucks 98 are returned to their initial alignment in which the first curved surface 99 of each puck 98 is at a radially outermost position. In this way, as each puck 98 returns to the elastic-application position, it receives the next elastic strip 106, and so the process continues.

Each of the pucks 98 can be actuated to oscillate individually using stationary spiral cam tracks and multiple cam followers positioned around a pivot point of an arm supporting each of the pucks. The rotating devices can each be a high efficiency interface roll, as disclosed in U.S. Pat. No. 5,556,504 to Rajala et al. Other examples of suitable rotating devices are disclosed in U.S. Pat. No. 5,716,478 to Boothe et al. and U.S. Pat. No. 5,759,340 to Boothe et al. Additionally, cam boxes, gear racks, bevel gears, and hinge points with plows are other examples of suitable rotating devices.

FIGS. 8 and 9 show a portion of the web 54 as it passes over the vacuum assembly drum 88, with the adhesive applicator 90 and the rotating devices 92 omitted for clarity. As can be seen, once adhesive 110 has been applied to the web 54 adjacent the curved leg openings 82, the curved leg elastics 106 are applied to the web 54 so as to extend along the leg openings.

Application of the leg elastics 106 is not limited to the use of rotating devices and pucks of the type described above and in U.S. Pat. No. 6,533,879. It should be appreciated that any suitable apparatus for applying a curved leg elastic to the web may be used. Examples of other devices that could be used include the devices disclosed in U.S. Pat. No. 4,578,133 to Oshefsky et al. and U.S. Pat. No. 6,540,857 to Coenen et al. It will also be appreciated that the leg elastics 106 need not be bonded to the web 54 by adhesive bonding, and that other types of bonding could be used, such as, for example, ultrasonic bonding, thermal bonding, pressure bonding or other conventional techniques.

Referring again to FIG. 4, a web 112 of material for forming the inner layer or moisture barrier of the outer cover 34 can be unwound from a supply roll 114 which can be driven by a variable speed drive roll (not illustrated), and which operates in conjunction with a web tension dancer roll 116 and a web guide 118 to ensure that this web is unwound with web tension control and web path control. In this aspect of the invention, the web 112 includes printed characters and is fed through a device 120, such as a registered graphics moisture barrier nip, for controlling the phase relationship between the characters printed on the moisture barrier material and other components of the web 54. Typically, the registered graphics moisture barrier nip is driven by a variable speed drive (not shown), and the web 112 is stretched in response to relative positions of other components on the web 54 to control the phase relationship between the printed characters on the moisture barrier and the other outer cover material components. A further adhesive applicator 122 may be used to apply adhesive to the web 54 immediately upstream of the registered graphics moisture barrier nip for bonding the web 112 to the web 54. Examples of suitable processes and apparatus for registering printed graphics on a first web with components on a second web include those disclosed in U.S. Pat. No. 5,766,389 and U.S. Pat. No. 5,818,719, both to Brandon et al.

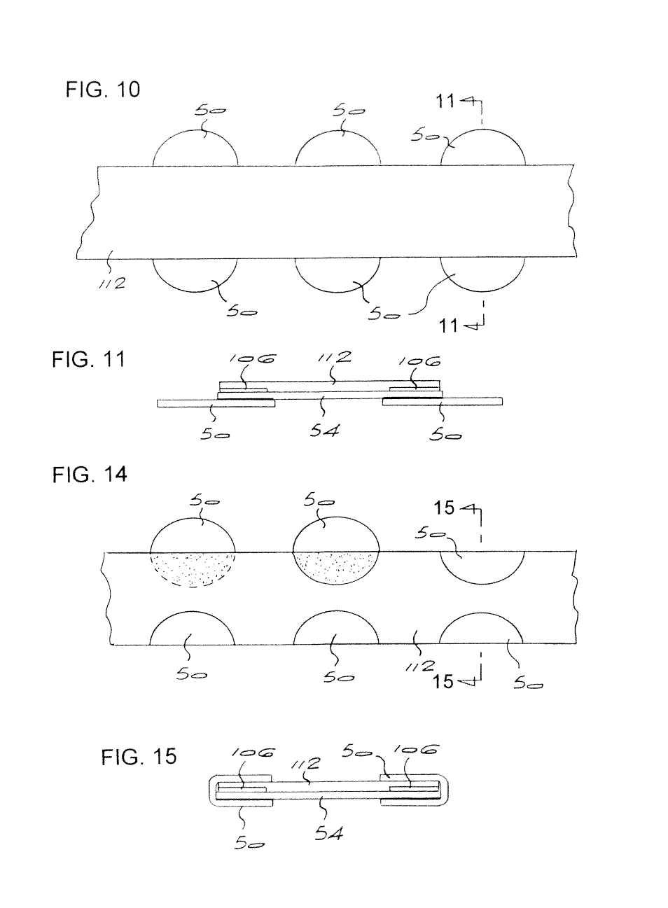

In FIGS. 10 and 11, the moisture barrier material web 112 is shown bonded to the outer cover outer layer material web 54 so as to sandwich the leg elastics 106 between the moisture barrier material and the outer cover outer layer material.

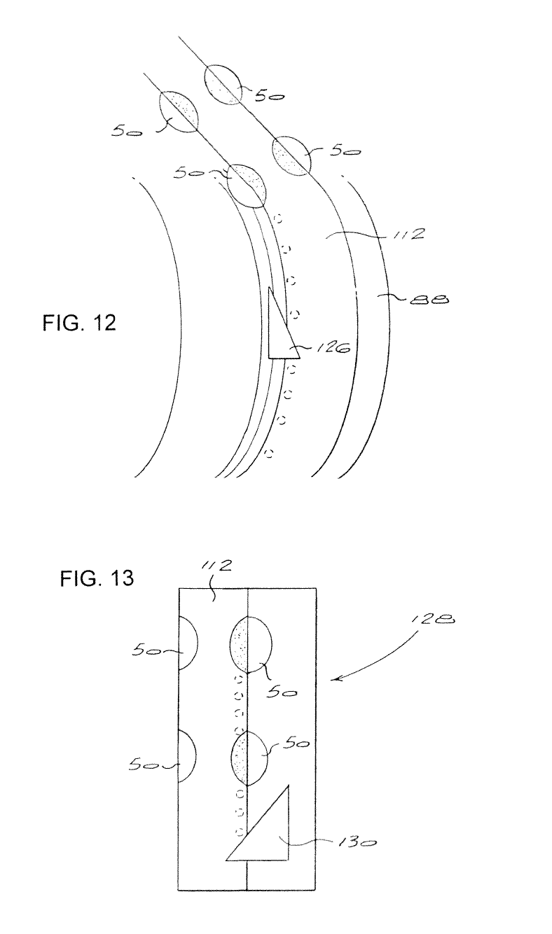

The outer cover material web may then pass a further adhesive applicator 124, as representatively illustrated in FIG. 4, which applies adhesive to the moisture barrier material 112 adjacent the leg bands 50. With reference also to FIG. 12 of the drawings, the outer cover material may then travel past a leg band folding ski 126 which serves in conjunction with the vacuum pressure in the vacuum drum assembly 88 to raise the leg bands 50 on one side of the outer cover material and fold these leg bands onto the leg band adhesive on the moisture barrier material 112. Upon emerging from the vacuum drum assembly 88, the outer cover material may travel past a further vacuum conveyor 128, as shown in FIG. 4. This vacuum conveyor is illustrated in more detail in FIG. 13. As can be seen, the vacuum conveyor 128 may include a further leg band folding ski 130 which together with the vacuum pressure on the vacuum conveyor 128, can raise the leg bands 50 on the other side of the outer cover material and fold these leg bands onto the leg band adhesive on the moisture barrier material 112. FIGS. 14 and 15 illustrate the leg bands 50 as they are folded over and bonded to the moisture barrier material 112.

It will be appreciated that the leg bands 50 may be folded by any suitable means, and that the folding of the leg bands is not limited to folding skis on a vacuum drum or a vacuum conveyor. Furthermore, the leg bands 50 on both sides of the web 112 may be folded simultaneously, either by a pair of folding skis on a vacuum drum or a pair of folding skis on a vacuum conveyor.

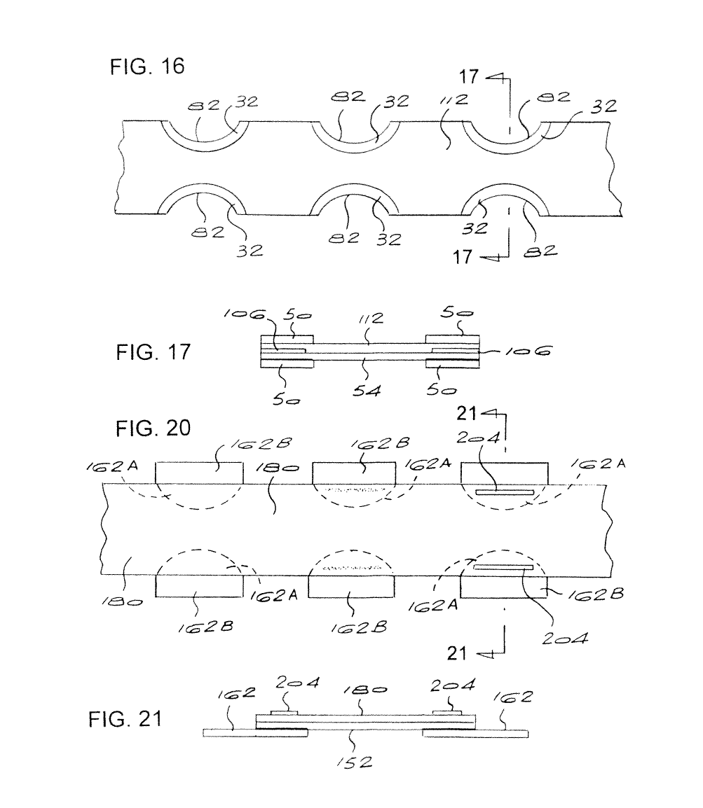

Referring again to FIG. 4, a further die cutter 132 is then used to cut the applied leg bands 50 to re-form the leg openings 82. FIGS. 16 and 17 representatively illustrate the resulting configuration of the web 54, in which the outer cover web is seen to include leg openings 82 with elasticised leg cuffs 32 extending around the leg openings in accordance with the first aspect of the invention.

It will be understood that, in other aspects of the invention, the web 54 may pass onto the vacuum conveyor 62 without passing through the die cutter 64, and that the leg openings 82 may be formed by simultaneously cutting the webs 54 and 112 and the leg bands 50 with the die cutter 132.

Suitable adhesives for use by the various adhesive applicators include spray adhesives, hot-melt adhesives, self-adhering elastomeric materials and the like. The adhesives may be applied continuously or intermittently, as beads, a spray, parallel swirls, or the like. Suitable adhesives may be obtained from Bostik Findley Adhesives, Inc., of Wauwatosa, Wis., U.S.A., or from National Starch and Chemical Company, of Bridgewater, N.J., U.S.A.

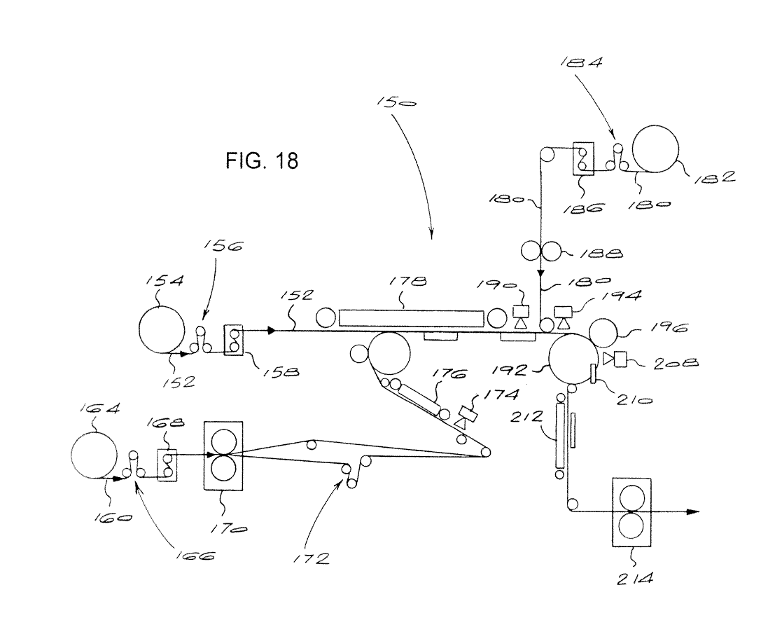

FIG. 18 illustrates a schematic side view of an apparatus 150 for forming outer covers for absorbent articles in a method according to a second aspect of the invention. In this aspect of the invention, a web 152 of material for forming the outer layers of the outer covers may be unwound from a supply roll 154, and may pass through a web tension dancer roll 156 and a web guide 158 in a similar manner to that described above with reference to the first aspect of the invention. However, the web 152 is not fed through a die cutter and hence is not shaped to include curved leg openings, as is the case in the first aspect of the invention.

At the same time, a web 160 of material for forming leg bands may be unwound from a supply roll 164 which operates in conjunction with a web tension dancer roll 166 and a web guide 168 to ensure that this web is unwound with web tension control and web path control in a similar manner to that described above with reference to the first embodiment of the invention. The web 160 may then pass through a die cutter 170, which shapes and cuts the leg bands, and a web path adjustment arrangement 172 which brings the left and right die-cut, leg bands into alignment with one another. An adhesive applicator 174 may be used to apply adhesive to shaped portions of the leg bands, and a vacuum feed conveyor 176 may be used to feed the leg bands into engagement with the web 152 on a vacuum conveyor 178 where the leg bands are bonded to the web 152.

Downstream of the vacuum conveyor 178, a web 180 of material for forming the inner layer or moisture barrier of the outer cover is unwound from a supply roll 182 which operates in conjunction with a web tension dancer roll 184 and a web guide 186 to ensure that this web is unwound with web tension control and web path control. The web 180 may include printed characters and may be fed through a device 188, such as a registered graphics moisture barrier nip, in a similar manner to that described above with reference to the first aspect of the invention, for controlling the phase relationship between the characters printed on the web 180 and other components of the outer cover material. A further adhesive applicator 190 may be used to apply adhesive to the web 152 immediately upstream of the registered graphics moisture barrier nip for bonding the web 180 to the web 152.

The web of outer cover material may then pass onto a vacuum assembly drum 192. An adhesive applicator 194 may be used to apply adhesive to the web 180, adjacent the leg bands, and leg elastics may then be applied to the web 180 on the vacuum assembly drum 192. In this aspect of the invention, the leg elastics are straight leg elastics which are applied to the web 180 by means of a rotating device 196 which receives elastic material from supply rolls (not illustrated).

The rotating device 196 is illustrated in more detail in FIG. 19 of the drawings in which it is seen to include a rotatable drum 198 which is arranged to engage the web 180 on the vacuum assembly drum 192. The drum rotates in a direction complementary to the machine direction movement of the web 180, as illustrated by the arrow “B”, and may be driven by any suitable drive means (not illustrated). The drive means for the drum 198 may include an electric motor (not shown) which transmits drive to the drum via a gearbox (also not shown).

Elastic ribbons 200 can pass over guide rolls 202 as they are fed towards the drum 198, and the ribbons 200 can be deflected onto the drum and can be cut into elastic strips 204 by one or more cutting devices 206. The cutting devices may be mechanical pinch-type cut-off knives, shear-type cut-off knives, hot knives or other cutting means well known in the art. The elastic ribbons suitably are stretched to at least 125%, more suitably at least 150%, of their initial (unstretched) length as they are applied to the drum 198, and the elastic ribbons are received on the drum 198 as straight or substantially straight elastic strips which are rotated on the drum into contact with the moving web 180 for bonding to this web. The outer surface of the drum 198 may have a non-slip texture on at least a part of this surface for holding the elastic strips 204 in place.

The drum 198 is arranged so that the elastic strips 204 are brought into contact with the web 180, and are bonded to this web, adjacent the leg bands, with bonds that are strong enough to separate the elastic strips 204 from the non-slip textured surface of the drum.

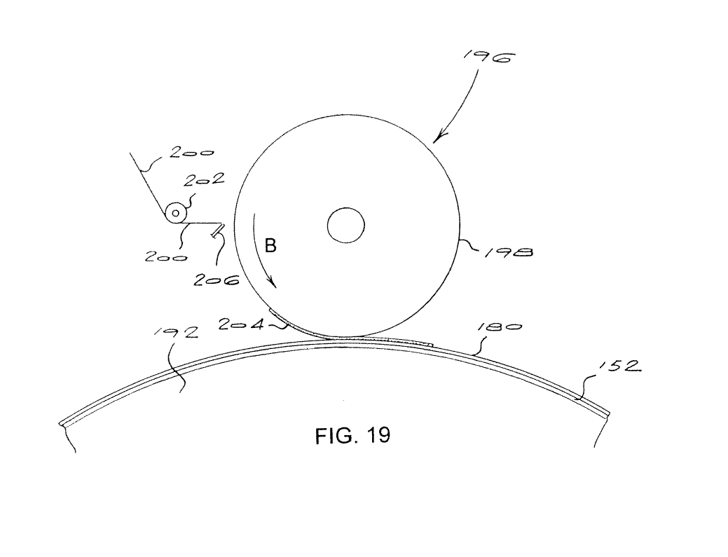

FIGS. 20 and 21 illustrate the web 180 for forming the barrier layer on the outer cover bonded to the web 152 for forming the outer layer for the outer cover, and discrete elastic strips 204 bonded to the moisture barrier material web 180, adjacent leg bands 162. As can be seen, the leg bands 162 may include curved outer portions 162A bonded to the web 152, and straight inner portions 162B projecting laterally from the web 152.

The bonded webs 152 and 180 may then pass a further adhesive applicator 208, as representatively illustrated in FIG. 18, which applies adhesive to the web 180 adjacent the leg bands 162. The webs 152 and 180 then travel past a leg band folding ski 210 which serves in conjunction with the vacuum pressure in the vacuum drum assembly 192 to raise the leg bands 162 on one side of the web 180 and fold these leg bands onto the leg band adhesive on the web 180 in a similar manner to that described above with reference to the first aspect of the invention. Upon emerging from the vacuum drum assembly 192, the webs 152 and 180 travel past a further vacuum conveyor 212 similar to that described above with reference to FIG. 13 of the drawings. The vacuum conveyor 212 may include a further leg band folding ski which together with the vacuum pressure on the vacuum conveyor 212, can raise the leg bands 162 on the other side of the web 180 and fold these leg bands onto the leg band adhesive on the web 180. As with the earlier example, the leg bands 162 may be folded by any suitable means, and the leg bands 162 on both sides of the web 152 may be folded simultaneously, either by a pair of folding skis on a vacuum drum or a pair of folding skis on a vacuum conveyor. A further die cutter 214 may be used to cut the applied leg bands 162 to form leg openings in the outer cover.

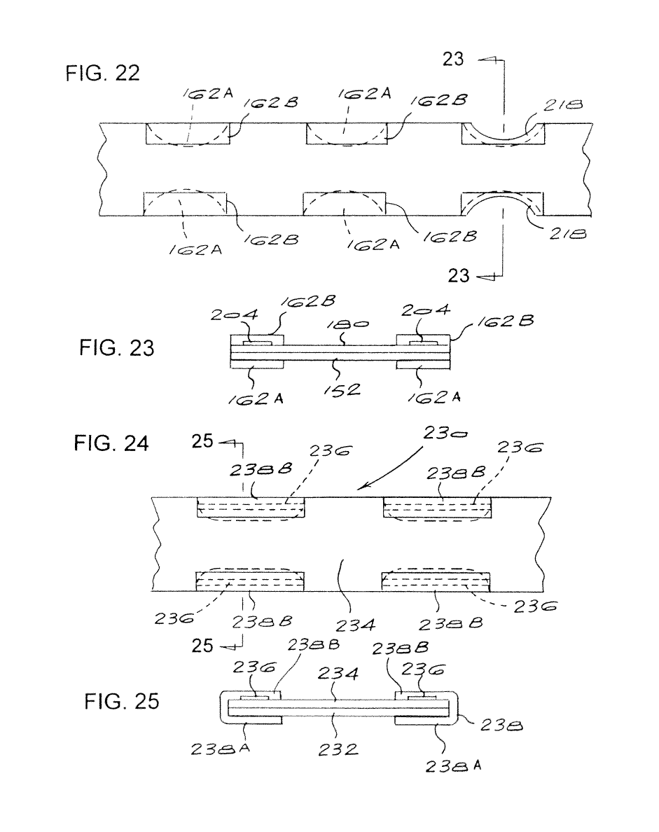

FIGS. 22 and 23 illustrate the leg band portions 162B as they are folded over and bonded to the web 180 to form, once cut by the die cutter 214, elasticised leg cuffs 218 in accordance with the second aspect of the invention.

FIGS. 24 and 25 illustrate an outer cover for an absorbent article according to another aspect of the invention. In this aspect, the outer cover 230 is seen to include an outer layer 232, an inner layer or moisture barrier 234 bonded to the outer layer 232, a straight leg elastic 236 bonded to the moisture barrier 234 and a folded leg band 238 which includes an outer, shaped portion 238A bonded to the outer layer 232, and an inner portion 238B bonded to the moisture barrier 234 so as to cover the leg elastic 236. As can be seen, the outer cover is not shaped to form curved leg openings, and hence the folded leg bands 238 are not cut at lateral edges of the outer cover.

It will be understood by those of skill in the art that the leg elastics could be applied as continuous strips instead of discrete strips. Also, it will be appreciated that the leg bands could have various different shapes, and that their shapes are not limited to those described above and illustrated in the accompanying drawings. Furthermore, the process could be modified to allow for the application of the leg bands in an elongated, stretched condition, if desired.

By applying leg elastics and leg bands in accordance with the method of the present invention, an outer cover for a pant-like absorbent garment can be produced with elasticised leg cuffs that are accentuated by the presence of additional material on the outside of the garment cover, especially if the colour, texture and/or stiffness of the leg band material differs from that of the outer cover material. Furthermore, the shape of the leg band portion on the outer surface of the outer cover may be selected to emphasise garment features such as crotch width, crotch length and elastic profiles, and since the leg band material is applied independently of the leg elastic, the shape and/or material of the leg band can be altered independently of the leg elastic.

While the invention has been described in detail with respect to specific embodiments thereof, it will be appreciated that those skilled in the art, upon attaining an understanding of the foregoing may readily conceive of alterations to, variations of and equivalents to these embodiments. Accordingly, the scope of the present invention should be assessed as that of the appended claims and any equivalents thereto.

What is claimed is:

1. A method of forming an elasticised leg cuff for a wearable article comprising:
providing a first web of material for forming at least part of an outer cover for a wearable article, the first web defining a first surface and an opposed second surface;
cutting a web of leg band material to form a discrete leg band having a first, shaped outer portion and a second, inner portion;
connecting the shaped outer portion of the discrete leg band to the first surface of the first web so that the inner portion of the discrete leg band extends laterally from a side edge of the first web;
connecting an elastic component to the first web, adjacent the discrete leg band; and
folding the inner portion of the leg band over the elastic component and connecting it to the second surface of the first web so as to cover at least a portion of the elastic component.

2. The method of claim 1, wherein the web of leg band material is cut and shaped to form the discrete leg band.

3. The method of claim 1, wherein the first web comprises material for forming an outer layer of the outer cover, and the method includes the step of connecting a second web to the second surface of the first web, the second web comprising material for forming an inner layer of the outer cover.

4. The method of claim 3, wherein the second web is connected to the second surface of the first web before the elastic component is connected to the first web.

5. The method of claim 3, wherein the second web is connected to the second surface of the first web after the elastic component is connected to the first web.

6. The method of claim 1, including the step of forming a leg opening in the first web, and connecting the shaped outer portion of the leg band to the first web adjacent the leg opening.

7. The method of claim 6, including the step of cutting the folded leg band to form a curved leg opening in the outer cover.

8. The method of claim 1, including the step of cutting the folded leg band to form a curved leg opening in the outer cover.

9. The method of claim 1, including the step of cutting and shaping the web of leg band material so as to form a shaped first, outer portion of the leg band and a shaped second, inner portion of the leg band.

10. The method of claim 1, wherein the web of leg band material comprises a stretchable material.

11. The method of claim 10, wherein the web of leg band material comprises an elastic material.

12. The method of claim 11, wherein the discrete leg band is stretched prior to connecting the outer portion of the leg band to the first web.

13. The method of claim 1, wherein the leg band is adhesively bonded, thermally bonded, ultrasonically bonded or pressure bonded to the first web.

14. The method of claim 6, including the step of connecting the elastic component to the first web adjacent the leg opening.

15. The method of claim 14, wherein the elastic component is a discrete leg elastic.

16. The method of claim 15, wherein the elastic component is a curved leg elastic.

17. The method of claim 15, wherein the elastic component is a straight leg elastic.

18. The method of claim 1, wherein the elastic component is a discrete leg elastic.

19. The method of claim 18, wherein the elastic component is a curved leg elastic.

20. The method of claim 18, wherein the elastic component is a straight leg elastic.

21. The method of claim 1, wherein the elastic component is a continuous leg elastic.

22. The method of claim 1, wherein the elastic component is formed from a composite elastic material.

23. The method of claim 1, wherein the elastic component is stretched prior to attachment to the web.

24. The method of claim 1, wherein the elastic component is adhesively bonded, thermally bonded, ultrasonically bonded or pressure bonded to the first web or the second web.
